(19) United States
(12) Patent Application Publication
(10) Pub. No.: US 2017/0276967 A1
(43) Pub. Date: Sep. 28, 2017

(54) EYEGLASS STRUCTURE

(71) Applicant: T-LINK PPE LTD., Taipei City (TW)

(72) Inventor: CHIEN-MEI LIN, TAIPEI CITY (TW)

(21) Appl. No.: 15/079,048

(22) Filed: Mar. 24, 2016

(51) Int. Cl. G02C 11/08; G02C 1/06

(52) U.S. Cl. CPC G02C 11/08; G02C 1/06; G02C 2200/08

(57) ABSTRACT

An eyeglass structure includes a front light-penetrable portion flanked by two parallel guide walls each having a free end with a leg pivotal connection portion; a rear frame portion flanked by two sliding bodies each having a free end with a stop wall, with each sliding body disposed between the guide walls, and each stop wall between a corresponding one of the sliding bodies and a corresponding one of the leg pivotal connection portions; a demountable connection portion connected to the front light-penetrable portion and the rear frame portion; and two legs pivotally connected to the leg pivotal connection portions to stop the stop walls, respectively. Hence, the eyeglass structure enables the front light-penetrable portion and rear frame portion to be firmly coupled together.

### FIELD OF THE INVENTION

The present invention relates to eyeglass structures and, more particularly, to an eyeglass structure with a front light-penetrable portion and a rear frame portion which are conducive to firm assembly.

### BACKGROUND OF THE INVENTION

In recent years, to enable eyeglasses to be capable of effecting ventilation and replacement of lenses and being worn comfortably, eyeglasses are designed to come with a front frame and a rear frame. The front frame has a lens and performs the aforesaid functions through the rear frame. However, the rear frame must have a complicated structure whereby the rear frame is coupled to the front frame, thereby rendering assembly difficult. Accordingly, it is imperative to provide an eyeglass structure with a front light-penetrable portion and a rear frame portion which are conducive to firm assembly.

### SUMMARY OF THE INVENTION

In view of the drawbacks of the conventional, the inventor of the present invention conducted extensive researches and experiments according to the inventor's years of experience in the related industry, and finally developed an eyeglass structure as disclosed in the present invention to provide a front light-penetrable portion and a rear frame portion which are conducive to firm assembly.

In order to achieve the above and other objectives, the present invention provides an eyeglass structure, comprising: a front light-penetrable portion flanked by two parallel guide walls each having a free end with a leg pivotal connection portion; a rear frame portion flanked by two sliding bodies each having a free end with a stop wall, with each sliding body disposed between the guide walls, and each stop wall between a corresponding one of the sliding bodies and a corresponding one of the leg pivotal connection portions; a demountable connection portion connected to the front light-penetrable portion and the rear frame portion; and two legs pivotally connected to the leg pivotal connection portions to stop the stop walls, respectively.

Regarding the eyeglass structure, each sliding body has an embedding body, with each embedding body having an outer inserting body and an inner inserting body, with the outer inserting bodies being disposed on the inner inserting bodies and protruding from the inner inserting bodies, respectively, with the inner inserting bodies being disposed on the sliding bodies, respectively, wherein a wall is disposed between the guide walls to form a slot, and a notch is disposed on a back of each wall, with each sliding body being positioned outside a wall of each slot, with the outer inserting bodies inserted into the slots, respectively, and the inner inserting bodies inserted into the notches, respectively.

Regarding the eyeglass structure, the demountable connection portion has at least an upper engaging arm and at least a lower engaging arm, with the upper engaging arm disposed in front of and above the rear frame portion to engage with the front light-penetrable portion from above, with the lower engaging arm disposed in front of and below the rear frame portion to engage with the front light-penetrable portion from below.

Regarding the eyeglass structure, a plurality of ventilation grooves is disposed on a front of the rear frame portion to define a plurality of ventilation channels together with a back of the front light-penetrable portion.

Regarding the eyeglass structure, each embedding body has a stop body, with the stop bodies disposed at the inner inserting bodies and protruded from the inner inserting bodies, respectively.

Hence, the eyeglass structure of the present invention enables the front light-penetrable portion and rear frame portion to be firmly coupled together.

### BRIEF DESCRIPTION OF THE DRAWINGS

Objectives, features, and advantages of the present invention are hereunder illustrated with specific embodiments in conjunction with the accompanying drawings, in which:

FIG. 1 is the exploded view 1 of an eyeglass structure according to a preferred embodiment of the present invention;

FIG. 2 is the exploded view 2 of the eyeglass structure according to the preferred embodiment of the present invention;

FIG. 3 is the perspective view 1 of an embedding body and a sliding body according to the preferred embodiment of the present invention;

FIG. 4 is the perspective view 2 of the embedding body and the sliding body according to the preferred embodiment of the present invention;

FIG. 5 is a perspective view of a slot according to the preferred embodiment of the present invention;

FIG. 6 is a schematic view of the eyeglass structure assembled according to the preferred embodiment of the present invention;

FIG. 7 is a schematic view of the eyeglass structure and legs assembled according to the preferred embodiment of the present invention;

FIG. 8 is a front schematic view of the eyeglass structure assembled according to the preferred embodiment of the present invention;

FIG. 9 is a rear schematic view of the eyeglass structure assembled according to the preferred embodiment of the present invention;

FIG. 10 is a cross-sectional view 1 of embedding bodies and slots assembled according to the preferred embodiment of the present invention; and

FIG. 11 is a cross-sectional view 2 of embedding bodies and slots assembled according to the preferred embodiment of the present invention.

### DETAILED DESCRIPTION OF THE PREFERRED EMBODIMENTS

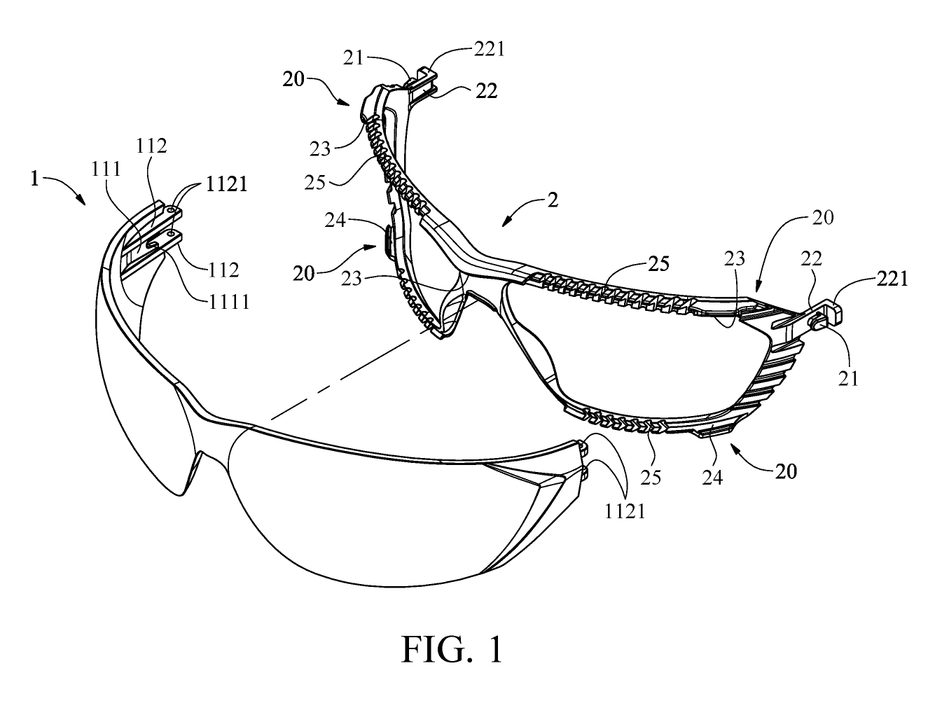

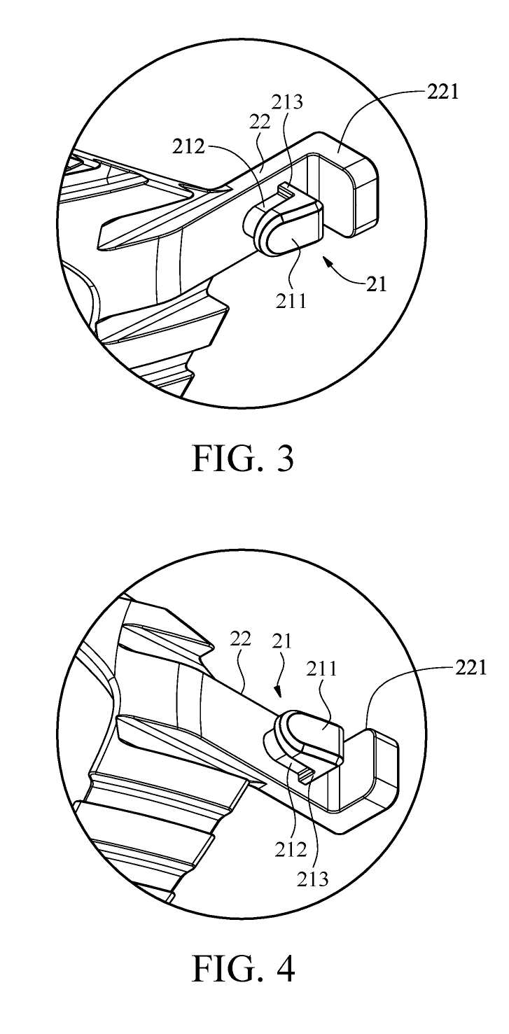

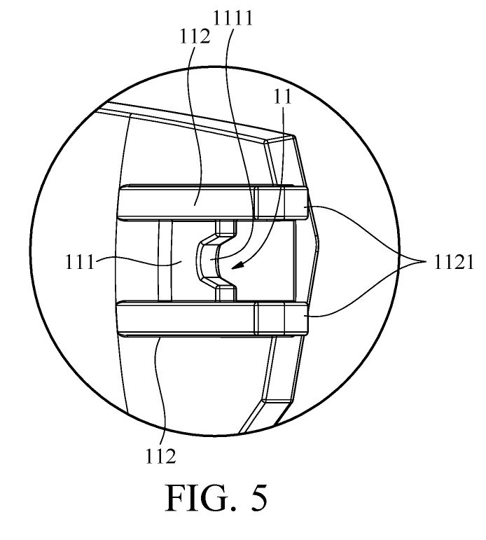

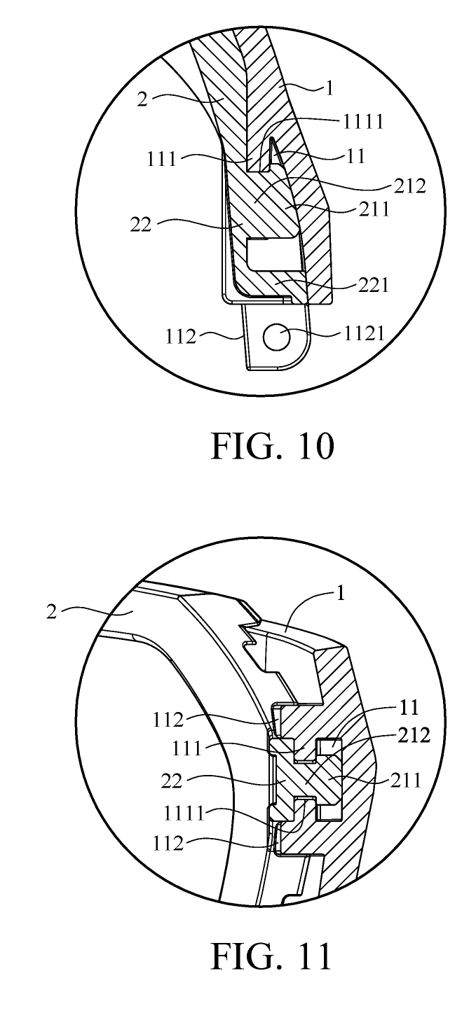

Referring to FIG. 1 through FIG. 11, wherein FIG. 10 is a cross-sectional view of slots 11 and embedding bodies 21 taken along a vertical line extending from the right of a front light-penetrable portion 1 to the right of a rear frame portion 2 shown in FIG. 9, whereas FIG. 11 is a cross-sectional view of the slots 11 and embedding bodies 21 taken along a horizontal line extending from the right of the front light-penetrable portion 1 to the right of the rear frame portion 2 shown in FIG. 9. As shown in the diagrams, the present invention provides an eyeglass structure which comprises a front light-penetrable portion 1, a rear frame portion 2, a demountable connection portion 20 and two legs 3. The front light-penetrable portion 1 has a single lens or integrally-formed double-lenses. Alternatively, the front light-penetrable portion 1 has a front frame (not shown) for mounting a single lens or double-lenses. The single lens and the double-lenses are planar, concave, convex or filtering. The front light-penetrable portion 1 is flanked by two parallel guide walls 112. A leg pivotal connection portion 1121 (such as a pivotal connection hole) is disposed at each of the free ends of the guide walls 112. The guide walls 112 face the back of the front light-penetrable portion 1. The rear frame portion 2 is flanked by two sliding bodies 22. A stop wall 221 is disposed at the free end of each sliding body 22. Each sliding body 22 is disposed between the guide walls 112. Each stop wall 221 is disposed between a corresponding one of the sliding bodies 22 and a corresponding one of the leg pivotal connection portions 1121. The sliding bodies 22 face the back of the rear frame portion 2. The stop walls 221 face the left and right of the rear frame portion 2, respectively, to form the shapes of L, together with the sliding bodies 22, respectively. Alternatively, the stop walls 221 are the walls of the free ends of the sliding bodies 22, respectively, and thus do not face the rear frame portion 2. Each stop wall 221 is disposed between the guide walls 112. The demountable connection portion 20 is connected to the front light-penetrable portion 1 and the rear frame portion 2. Alternatively, the demountable connection portion 20 ensures that the front light-penetrable portion 1 and the rear frame portion 2 are separated from each other. The pivotal connection ends 31 of the legs 3 are pivotally connected to the leg pivotal connection portions 1121 to stop the stop walls 221, respectively.

When the demountable connection portion 20 gets connected to the front light-penetrable portion 1, each sliding body 22 slides into between the guide walls 112; then, when the pivotal connection ends 31 of the legs 3 are pivotally connected to the leg pivotal connection portions 1121 of the free ends of the guide walls 112, respectively, the pivotal connection ends 31 of the legs 3 stop the stop walls 221, respectively. Hence, the front light-penetrable portion 1 and the rear frame portion 2 are connected by the demountable connection portion 20. Furthermore, the guide walls 112 limit the vertical displacement of each sliding body 22, whereas the pivotal connection ends 31 of the legs 3 limit the forward and backward displacement of each stop wall 221, so as to limit the vertical, forward and backward displacement of the rear frame portion 2, thereby rendering it easy for the rear frame portion 2 to be firmly coupled to the front light-penetrable portion 1.

Referring to FIG. 1 through FIG. 6, FIG. 10 and FIG. 11, regarding the eyeglass structure, each sliding body 22 has an embedding body 21. The embedding bodies 21 face the left and right of the rear frame portion 2, respectively. Each embedding body 21 has an outer inserting body 211 and an inner inserting body 212. The outer inserting bodies 211 are disposed on the inner inserting bodies 212 and protruded from the inner inserting bodies 212, respectively. The inner inserting bodies 212 are disposed on the sliding bodies 22, respectively. A wall 111 is disposed between the guide walls 112 such that a slot 11 is formed between the front light-penetrable portion 1, the guide walls 112 and the wall 111. Each slot 11 opens toward the back of the front light-penetrable portion 1. A notch 1111 is disposed on the back of each wall 111. The sliding bodies 22 are positioned outside the walls 111 of the slots 11, respectively. The outer inserting bodies 211 are inserted into the slots 11, respectively. The inner inserting bodies 212 are inserted into the notches 1111, respectively. Hence, the rear frame portion 2 is firmly coupled to the front light-penetrable portion 1, because the outer inserting bodies 211 are inserted into the slots 11 of the front light-penetrable portion 1, respectively, and the inner inserting bodies 212 are inserted into the notches 1111 of the front light-penetrable portion 1, respectively. The slots 11 are blocked by the stop walls 221, respectively, to prevent foreign bodies from intruding into the slots 11.

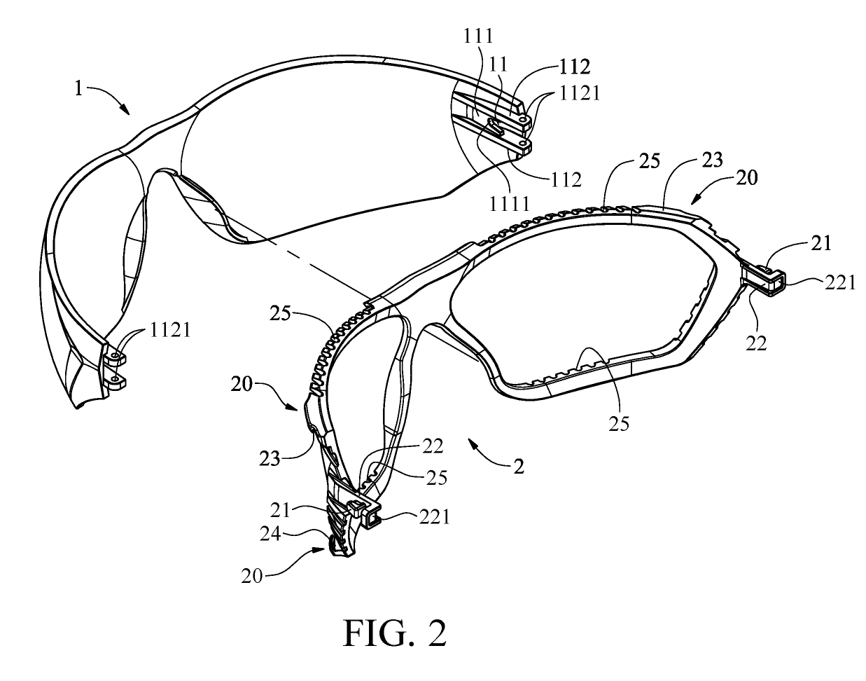

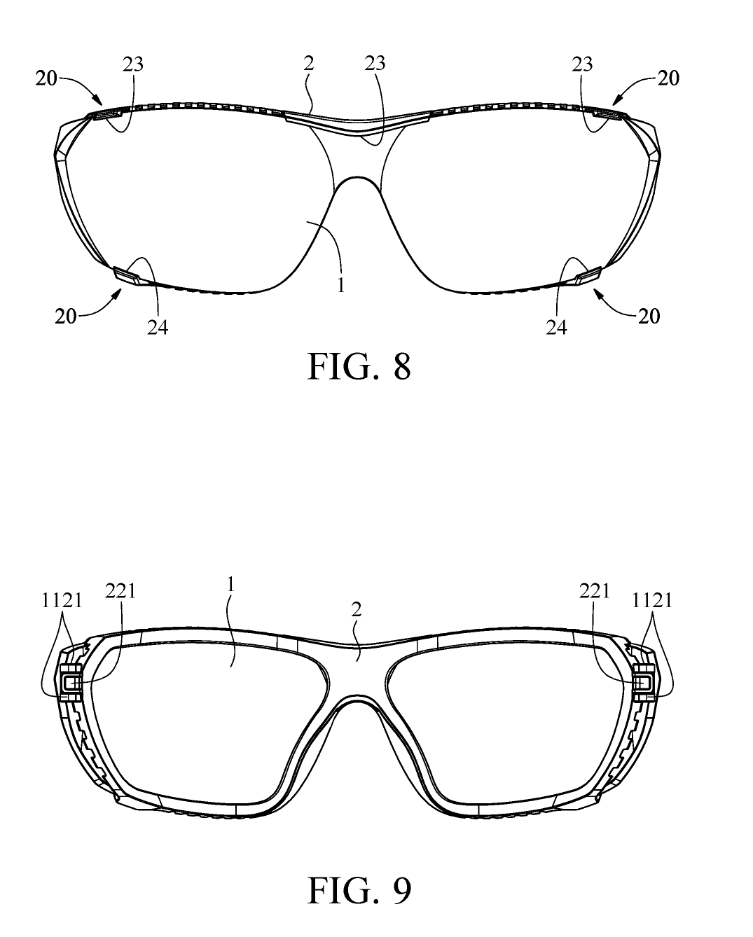

Referring to FIG. 1, FIG. 2 and FIG. 8, regarding the eyeglass structure, the demountable connection portion 20 has at least an upper engaging arm 23 and at least a lower engaging arm 24. The upper engaging arm 23 is disposed in front of and above the rear frame portion 2 to engage with the front light-penetrable portion 1 from above. The lower engaging arm 24 is disposed in front of and below the rear frame portion 2 to engage with the front light-penetrable portion 1 from below. Hence, the rear frame portion 2 can be coupled to and separated from the front light-penetrable portion 1 through the upper engaging arm 23 and the lower engaging arm 24.

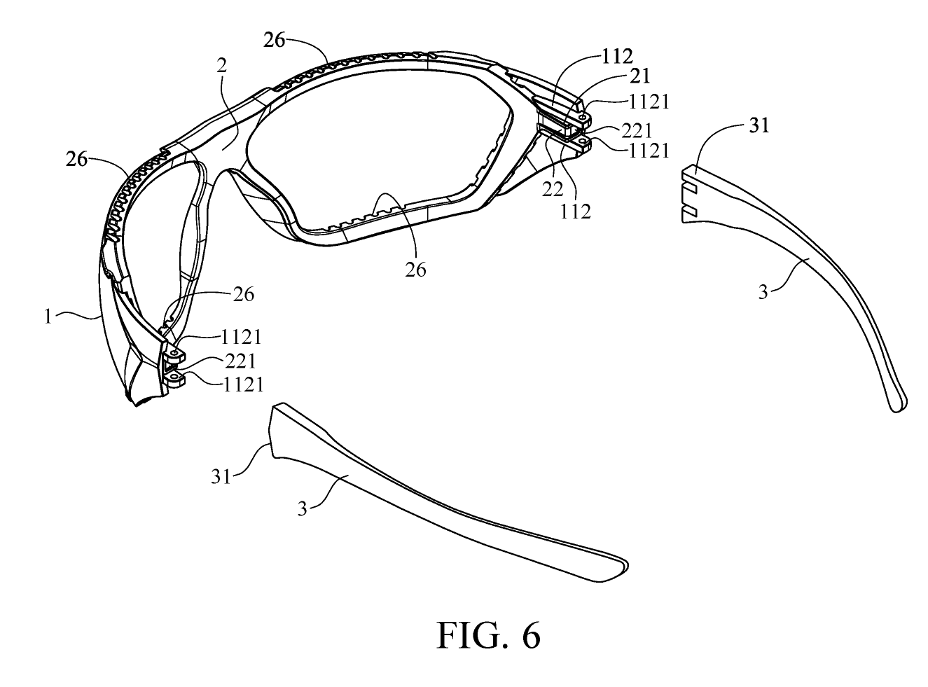

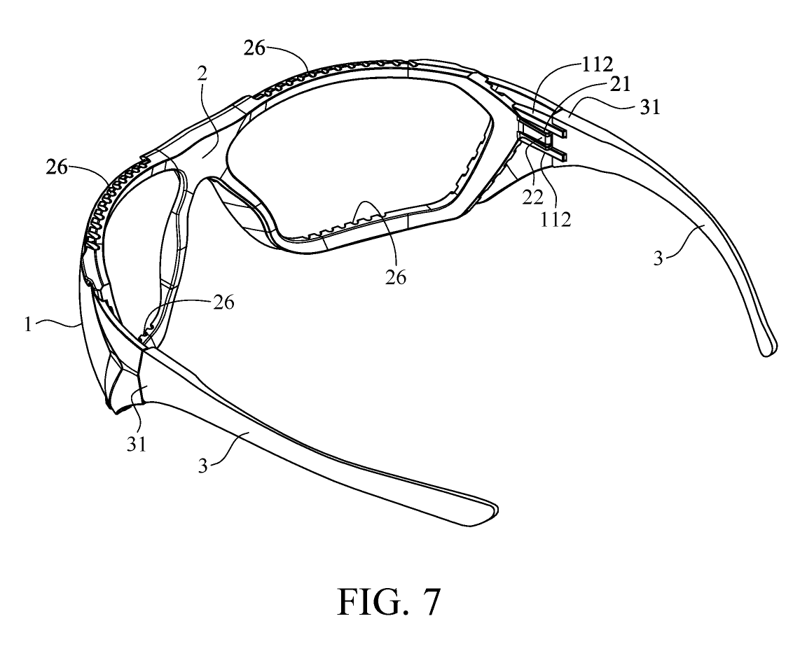

Referring to FIG. 1, FIG. 2, FIG. 6 and FIG. 7, regarding the eyeglass structure, a plurality of ventilation grooves 25 is disposed on the front of the rear frame portion 2, whereas the ventilation grooves 25 and the back of the front light-penetrable portion 1 together define a plurality of ventilation channels 26. Hence, due to the ventilation channels 26, the front light-penetrable portion 1 is unlikely to fog.

Referring to FIG. 1 through FIG. 6, regarding the eyeglass structure, each embedding body 21 has a stop body 213. The stop bodies 213 are disposed at the inner inserting bodies 212 and protruded from the inner inserting bodies 212, respectively. The outer inserting bodies 211 connect with the stop bodies 213 to form the shapes of L, respectively. The inner inserting bodies 212 are disposed at corners defined by and between the outer inserting bodies 211 and the stop bodies 213, respectively. Hence, upon insertion of the outer inserting bodies 211 of the rear frame portion 2 into the slots 11 of the front light-penetrable portion 1 and insertion of the inner inserting bodies 212 of the rear frame portion 2 into the notches 1111 of the front light-penetrable portion 1, respectively, the stop bodies 213 stop at the walls 111 from behind, respectively.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. An eyeglass structure, comprising:
a front light-penetrable portion flanked by two parallel guide walls each having a free end with a leg pivotal connection portion;
a rear frame portion flanked by two sliding bodies each having a free end with a stop wall, with each sliding body disposed between the guide walls, and each stop wall between a corresponding one of the sliding bodies and a corresponding one of the leg pivotal connection portions;
a demountable connection portion connected to the front light-penetrable portion and the rear frame portion; and
two legs pivotally connected to the leg pivotal connection portions to stop the stop walls, respectively.

2. The eyeglass structure of claim 1, wherein each sliding body has an embedding body, with each embedding body having an outer inserting body and an inner inserting body, with the outer inserting bodies being disposed on the inner inserting bodies and protruding from the inner inserting bodies, respectively, with the inner inserting bodies being disposed on the sliding bodies, respectively, wherein a wall is disposed between the guide walls to form a slot, and a notch is disposed on a back of each wall, with each sliding body being positioned outside a wall of each slot, with the outer inserting bodies inserted into the slots, respectively, and the inner inserting bodies inserted into the notches, respectively.

3. The eyeglass structure of claim 1, wherein the demountable connection portion has at least an upper engaging arm and at least a lower engaging arm, with the upper engaging arm disposed in front of and above on an upper portion of the rear frame portion to engage with the front light-penetrable portion from above, with the lower engaging arm disposed in front of and on an lower portion of the rear frame portion to engage with the front light-penetrable portion from below.

4. The eyeglass structure of claim 2, wherein the demountable connection portion has at least an upper engaging arm and at least a lower engaging arm, with the upper engaging arm disposed in front of and on an upper portion of the rear frame portion to engage with the front light-penetrable portion from above, with the lower engaging arm disposed in front of and on an lower portion of the rear frame portion to engage with the front light-penetrable portion from below.

5. The eyeglass structure of claim 1, wherein a plurality of ventilation grooves is disposed on a front of the rear frame portion to define a plurality of ventilation channels together with a back of the front light-penetrable portion.

6. The eyeglass structure of claim 2, wherein a plurality of ventilation grooves is disposed on a front of the rear frame portion to define a plurality of ventilation channels together with a back of the front light-penetrable portion.

7. The eyeglass structure of claim 3, wherein a plurality of ventilation grooves is disposed on a front of the rear frame portion to define a plurality of ventilation channels together with a back of the front light-penetrable portion.

8. The eyeglass structure of claim 4, wherein a plurality of ventilation grooves is disposed on a front of the rear frame portion to define a plurality of ventilation channels together with a back of the front light-penetrable portion.

9. (canceled)

10. The eyeglass structure of claim 2, wherein each embedding body has a stop body, with the stop bodies disposed at the inner inserting bodies and protruded from the inner inserting bodies, respectively.

11. (canceled)

12. The eyeglass structure of claim 4, wherein each embedding body has a stop body, with the stop bodies disposed at the inner inserting bodies and protruded from the inner inserting bodies, respectively.

13. (canceled)

14. The eyeglass structure of claim 6, wherein each embedding body has a stop body, with the stop bodies disposed at the inner inserting bodies and protruded from the inner inserting bodies, respectively.

15. (canceled)

16. The eyeglass structure of claim 8, wherein each embedding body has a stop body, with the stop bodies disposed at the inner inserting bodies and protruded from the inner inserting bodies, respectively.
